(19) United States
(12) Patent Application Publication
(10) Pub. No.: US 2026/0134098 A1
(43) Pub. Date: May 14, 2026

(54) EXPLAINABLE ARTIFICIAL INTELLIGENCE SYSTEM FOR DIGITAL FORENSICS

(71) Applicant: Zayed University, Dubai (AE)

(72) Inventors: Farkhund Iqbal, Abu Dhabi (AE); Zainab Khalid, Abu Dhabi (AE)

(73) Assignee: Zayed University, Dubai (AE)

(21) Appl. No.: 18/943,175

(22) Filed: Nov. 11, 2024

(51) Int. Cl. G06F 21/56

(52) U.S. Cl. CPC G06F 21/566

(57) ABSTRACT

A system includes an explainable artificial intelligence system. The system also includes a digital forensics system.

### BACKGROUND

Artificial Intelligence (AI) has seen many use cases in Digital Forensics (DF), such as making predictions about the timeline of events that lead to a potential breach or sifting through huge volumes (100s of GBs to TBs) of forensic evidence to narrow down artifacts relevant to an investigative case. However, the outcomes of digital investigations utilizing Artificial Intelligence cannot be explained to nontechnical professionals such as police officers, judges, jury members, witnesses, and other layman personnel in the court of law.

One reason is that the usual black-box AI model is non-transparent in that it offers no explanation about the predictions it makes since results are a culmination of vague numbers; even the designer of AI models cannot explain how it reached to a certain conclusion. Even findings of intrinsically explainable models like Decision Trees and Neural Networks may still be vague. Accordingly, currently there is no remedy to fill this gap between expert witness/DF investigator and nontechnical professionals (e.g., law enforcement office and a judge) in comprehending digital forensics investigation findings in order to confirm and verify forensic evidence/artifacts.

### BRIEF DESCRIPTION OF DRAWINGS

FIG. 1 is a diagram of an example flowchart;

FIG. 2 is a diagram of an example flowchart;

FIG. 3 is a diagram of an example flowchart;

FIG. 4 is a diagram of an example flowchart;

FIG. 5 is a diagram of an example table;

FIG. 6 is a diagram of an example table;

FIG. 7 is a diagram of an example networking environment;

FIG. 8 is a diagram of an example computer;

FIGS. 9A and 9B are diagrams of an example process;

FIG. 10 is a diagram of an example graphical display;

FIG. 11 is a diagram of an example table;

FIG. 12 is a diagram of an example screenshot; and

FIG. 13 is a diagram of an example screenshot.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein are an integration of XAI (eXplainable AI) and DF (Digital Forensics) that generates a proposed XAI-DF system. In embodiments, the XAI-DF system provides for a process of digital forensics investigation employing XAI for predictions and interpretable explanations. In embodiments, the XAI-DF system described herein provides for: (a) any digital forensics domain and type of evidence, (b) utilizing any suitable existing AI model (or designing custom models for specialized use), and (c) finally sourcing any explainability method for interpretability. Accordingly, the systems, methods, and/or devices described herein integrate multiple techniques, models and tools to produce digital forensic evidence that is explainable and interpretable. In embodiments, the input to the system can be raw data, such as memory dumps, network logs, email data, and/or police reports that are transformed into meaningful and intuitive digital evidence such as visuals of traits that can help uniquely identify a potential suspect to be convicted. The explanations obtained from XAI tools may be textual, visual, or graphical, etc. based on the specific forensic sub-domain.

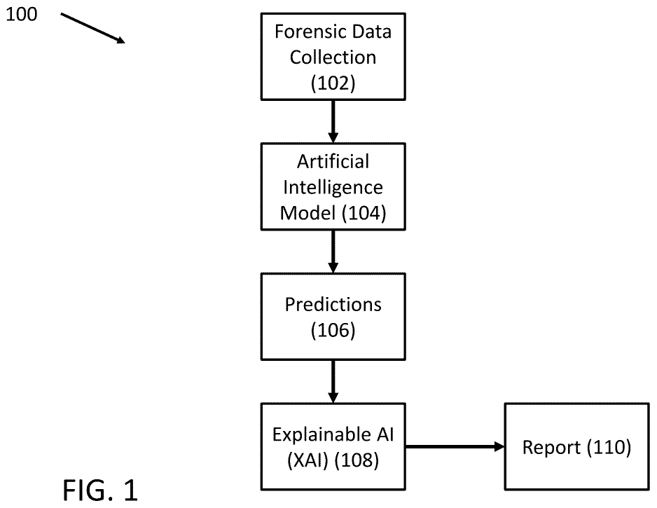

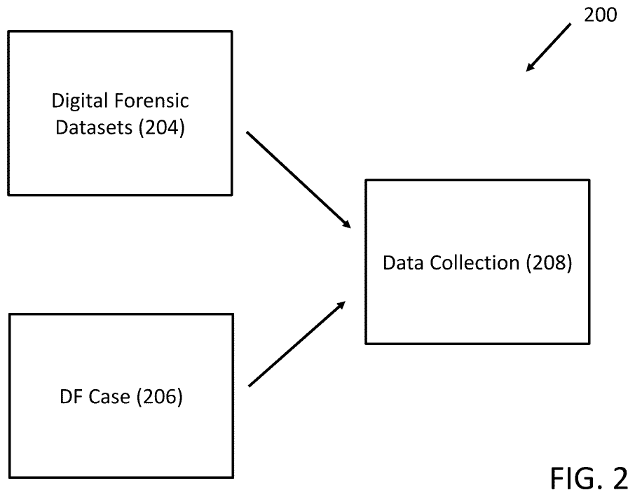

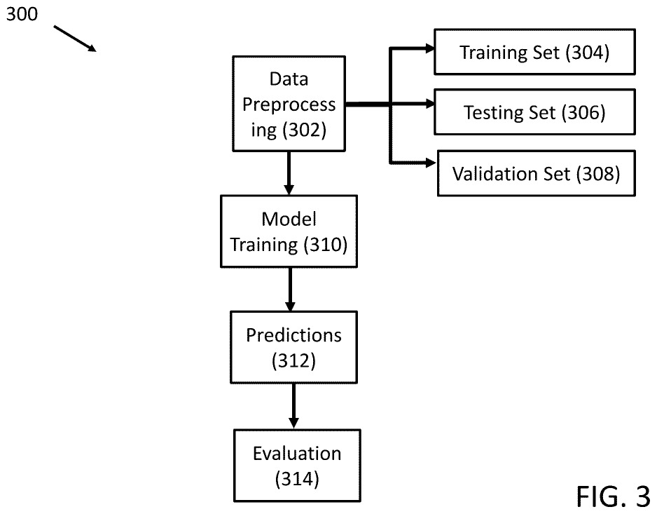

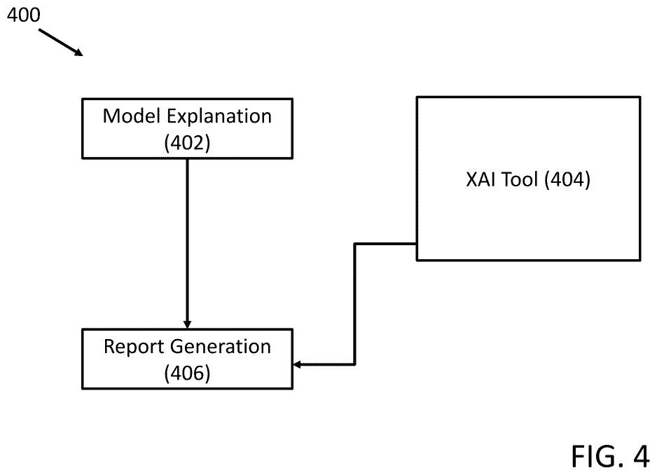

In embodiments, FIG. 1 describes flowchart 100 that describes an XAI-DF process. As shown in FIG. 1, flowchart 100 describes processes/systems 102, 104, 106, 108, and 110. In embodiments, shown in FIG. 1 and described as part of flowchart 100, the XAI-DF system includes the following processes: (1) forensic data collection 102, (2) Artificial Intelligence (AI) Model 104, (3) predictions 106, (4) explainable AI 108, and (5) report 110. FIG. 2 describes flowchart 200 which further describes one or more processes performed by the XAI-DF system for forensic data collection 102. FIG. 3 describes flowchart 300 which describes the processes associated with AI model 104 and prediction 106. FIG. 4 describes flowchart 400 which describes the processes associated with explainable AI 108 and report 110.

In embodiments, as shown in FIG. 2, the processes for forensic data collection 102 is shown by obtaining digital forensic datasets 204 which can include dataset(s)/database(s) of a digital forensics subdomain, such as from a (1) network, (2) hard drive (Operating System (OS)/file system), (3) RAM/memory, (4) mobiles/smartphones, (5) Internet of Things (IoT), (6) blockchain, (7) cloud/server, (8) social media, (9) multimedia (images, audio, video), (10) removable storage, and/or (11) any other type of device and/or system. In embodiments, this may include a pre-prepared dataset of forensic material (such as memory dumps, network traffic captures, or hard drive forensic images, etc., depending on the sub-domain) that is used for training AI models.

In embodiments, forensic data collection 102 may also include a novel DF case 206 which includes electronic information about digital forensics investigations at hand (such as child exploitation cases, intellectual property theft, fraud or ransomware investigations, etc.) may be input for both training and/or testing.

As such, this ensures real-time postmortem DF analysis capabilities are included in the framework. In embodiments, the pertinent data may be used to extract meaningful features in the feature extraction step of the next module. In embodiments, forensic tools may be used to extract and aggregate information from databases/case material that contain forensic images in raw form i.e., hexadecimal data. In embodiments, this is done to convert data into a more readable form before sending the data as an input to an AI model (as further described in FIG. 3). For example, for FIG. 3, a memory forensic analysis tool, such as Volatility, may be used to parse the memory for running processes and other registry or network artifacts, etc. Autopsy may be used to view, examine and extract different OS or user files from bit-by-bit hard drive forensic images, etc. and Wireshark or NetworkMiner may be used to analyze traffic captured from networking devices.

As shown in FIG. 2, the collection of DF case data 206 and digital forensic datasets 204 can be combined together to generate data collection 208.

In embodiments, data collection 208 ensures real-time postmortem DF analysis capabilities can be conducted by the XAI-DF system. In embodiments, received data by the XAI-DF system can be used to extract meaningful features in the feature extraction step of the next module.

FIG. 3 describes the processes associated with AI model 104. As shown in FIG. 3, AI model 104 includes data preprocessing 302. In embodiments, data preprocessing 302 includes data extraction and data cleaning to handle missing values, outliers, and inconsistencies by scaling and encoding. In embodiments, data preprocessing also includes training set 304, testing set 306, validation set 308.

In embodiments, training set 304 is used to train the model which then gives predictions on test data. In embodiments, the performance of the trained models is evaluated based on metrics such as accuracy, precision, recall, F1-score, Mean Absolute Error 250 (MAE), Mean Squared Error (MSE), etc. and the validation set may also be utilized to tune hyperparameters. In embodiments, testing set 306 is used to test the trained model using above mentioned metrics. In embodiments, validation set 308 is used to evaluate the model during training process for different training data batches or epoch.

In embodiments, model training 310 includes using one or more models that include decision trees, random forests, neural networks, gradient boosting machines, deep learning, and/or linear models etc. In embodiments, a model is selected either based on the investigator's preference or one which best fits the dataset type and/or classification accuracy requirements. In embodiments, the training process involves passing batches of training data 304 through the model while tuning parameters and performing validation with validation data 308. In embodiment, training concludes after reaching the specified number of epochs or error tolerance, set as hyperparameters. Subsequently, test data 306 evaluates model performance.

In embodiments, predictions 312 include the output of model training 310. In embodiments, the XAI-DF system allows for an automated selection process based on defining rule sets and preconditions that match the nature of the data. For example, if the forensic data reveals a linear dependency among extracted features (e.g., memory image characteristics), linear models, such as regression or decision trees, may be appropriate. For example, if the data relationships are complex or non-linear, the XAI-DF system may select a neural network, which can capture intricate patterns more effectively for accurate predictions.

In embodiments, evaluation 314 includes evaluation and hyperparameter tuning. In embodiments, the model analyzes multiple aspects during the hyperparameter tuning process depending on the relative preference of the forensic investigator. For example, this can be accuracy rate or explainability requirements in specific context. In embodiments, the XAI-DF system may perform tuning using gradient descent, predefined optimization algorithms, or backpropagation, depending on the model type. Evaluation occurs with testing data 306 and includes computing various metrics outlined as described above. Thus, these metrics guide adjustments, ensuring that the model meets the required performance criteria.

FIG. 4 describes process 400 which is conducted by Explainable AI system 108. As shown in FIG. 4, Explainable AI system 108 includes intrinsic model explanations 402 and XAI tool's explanations 404. In embodiments, model explanation 402 is generating explanations for the black box intrinsically explainable model's predictions using its inherently transparent structure. In embodiments 402, such models (such as Decision Trees and Neural Networks) are user friendly/explainable which means that they are relatively simple and transparent, and the user can understand visibly how the model reached to a certain conclusion. In embodiments, the explanations from XAI tool may be local/global, textual, or visualization-based, etc. In embodiments XAI tool 404 can create explanations for predictions through various methods, like model-agnostic approaches that perturb the input data and fit a simple, interpretable model locally to approximate the complex model's behavior, highlighting feature importance. In embodiments, these explanations may be corroborated with intrinsic/model-specific explanations for more clarity, if the AI model under use is intrinsically explainable.

In embodiments, databases of digital forensic images can be utilized for (but not limited to) training XAI models used in DF investigations. In a non-limiting example, an initial memory database of 27 memory dumps is detailed below, that focuses on malware activity in the memory. Accordingly, the initial memory database can be used to build a vast database consisting of forensic images of both memory and other sub-disciplines such as network traffic, hard drive/disk, and IoT devices such as smartphones and smart cards.

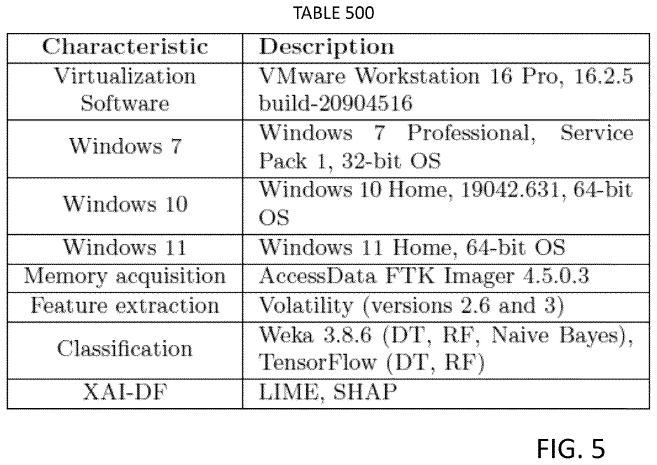

In embodiments, the memory database provides DF images for the example demonstration of the XAI DF system. Forensics research, in general, may also greatly benefit from such a database in many ways. In embodiments, Virtual Machines (VMs), operated via a controlled VMware Workstation Pro environment, and created with various Windows OSs' .iso images, i.e., Windows 7 Professional, Windows 10 Home and Windows 11 Home, were allotted 2 GB RAM, and 60 GB disk space. Table 5 in FIG. 5 describes the details used in this example environment. In embodiments, VMs were used as testbeds to simulate malicious activity.

In embodiments, since malware can infect a system through various methods, a random combination of activities is conducted for each VM to achieve an infected machine such as careless online surfing (visiting suspicious websites, clicking questionable pop-ups, downloading ambiguous games), or directly downloading and executing malware samples from resources.

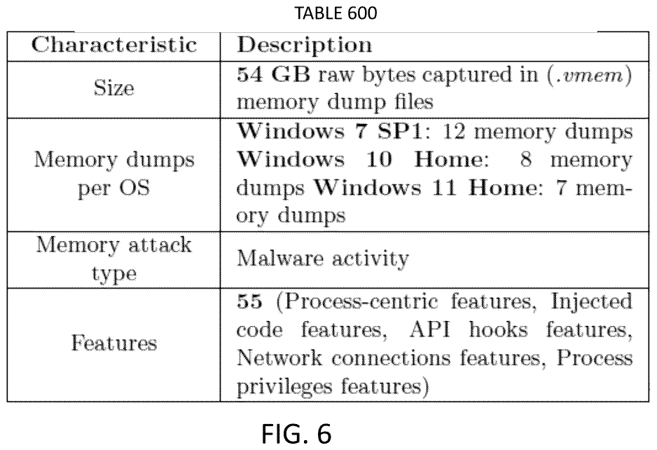

In embodiments, raw memory images, each 2 GB in size, were taken using the AccessData FTK Imager by suspending the VMs and creating duplicates of the .vmem file pertinent to each VM. In addition to memory dumps of malicious activity, some benign memory dumps consisting of normal user activity/benign running processes are also captured for each OS. Table 600 in FIG. 6 describes the characteristics of the memory database.

In embodiments, classification of the memory database (Memory Features Combined CSV.csv) using Weka's DT (J48), DT (LMT), DT (Hoeffding), Random Forest, and Naive Bayes gave accuracy scores of 93.75%, 445 94.55%, 92.16%, 95.35%, and 91.07%, respectively. The classification can use, but not limited to, Python's TensorFlow library; DT, RF, and DNN models. In addition, other libraries were used including Pandas for data manipulation, NumPy for numerical computations, Matplotlib for visualization, and scikit-learn modules for preprocessing, modeling, and evaluation. Memory_Features_Combined_CSV.csv was loaded using Pandas, followed by preprocessing steps which included separating features and label, and catering for categorical and numerical features.

In embodiments, after splitting the dataset into testing and training sets, DT, RF, and DNN models were defined and trained using scikit-learn and used for classification. Accuracy scores for DT, RF, and DNN models were 93.11%, 95.28%, and 93.47% respectively.

In embodiments, for XAI tool 404, LIME can be used to generate local explanations for the models' predictions. This involves initializing a LIME tabular explainer object, randomly choosing an instance from the test set to explain, and using LIME to explain the model's prediction for that particular instance, i.e., plotting feature importances.

As opposed to explanations of single instances that LIME produces, SHAP (or a similar tool) provides global explanations as well and can be used by XAI tool 404.

In a non-limiting example, a network traffic dataset comprising a total of 2,540,044 records. From these records, a subset is dedicated for training and testing purposes: UNSW_NB15_training-set.csv and UNSW_NB15_testing-set.csv containing 175,341 and 82,332 records, respectively. In embodiments, these records encompass different types of network activities, including both normal traffic and various forms of attacks. The UNSW-NB15 dataset is often used for evaluating and testing NIDSs. Its diverse range of attack scenarios makes it valuable for training and validating ML models for detecting network intrusions and anomalies. For this example of the XAI-DF system, the dataset in the context of a cybercrime forensic investigation is used, aiming to perform binary classification (to determine normal and attack traffic) and multiclass classification (to determine the various attack families).

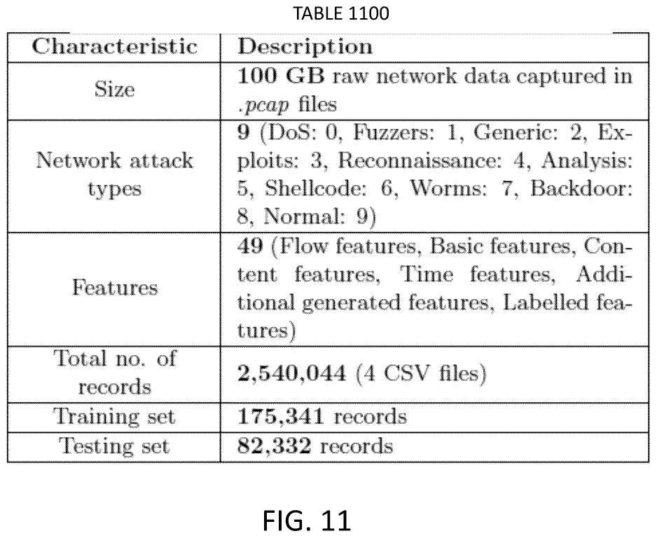

In embodiments, an AI model may be used for predictions/classification. For example, DT, RF, and DNN models were used to perform binary and multiclass classifications of the dataset using Python and TensorFlow. The ‘label feature in the dataset (which had 2 outcomes: 0 for normal traffic, 1 for abnormal traffic) is used as the target label for binary classification. The ‘attack cat’ feature (with 9 possible outcomes representing the 9 attack families specified in Table 1100 in FIG. 11) is used as the target label for multiclass classification.

Loading the training and testing sets' CSV files using Pandas, preprocessing steps included combining the datasets, separating features and target labels, encoding categorical targets into numerical labels, and preprocessing categorical and numerical columns separately. The dataset is then split into training and testing sets. A DT classifier is then defined and trained which then made predictions on the testing set and performance was evaluated using accuracy score and classification report metrics (precision, recall, F-score, etc.). The accuracy for DT binary and multiclass classifications was 98.4% and 85.1%, respectively. While accuracy for RF binary and multiclass classifications was 97.6% and 85.25%, respectively.

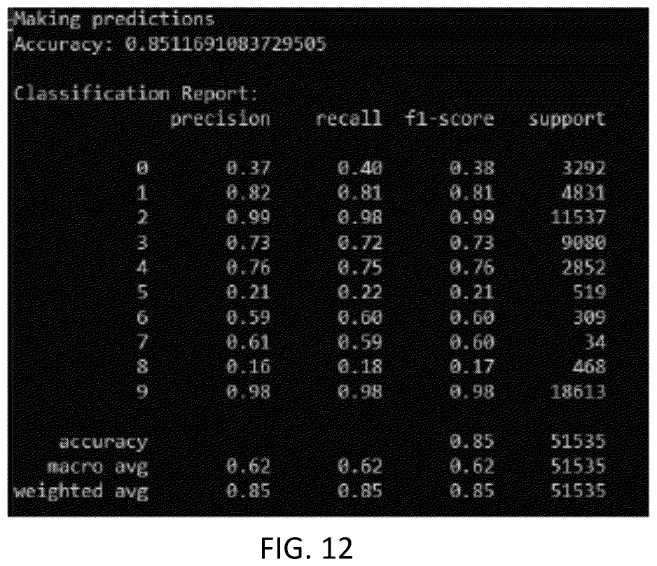

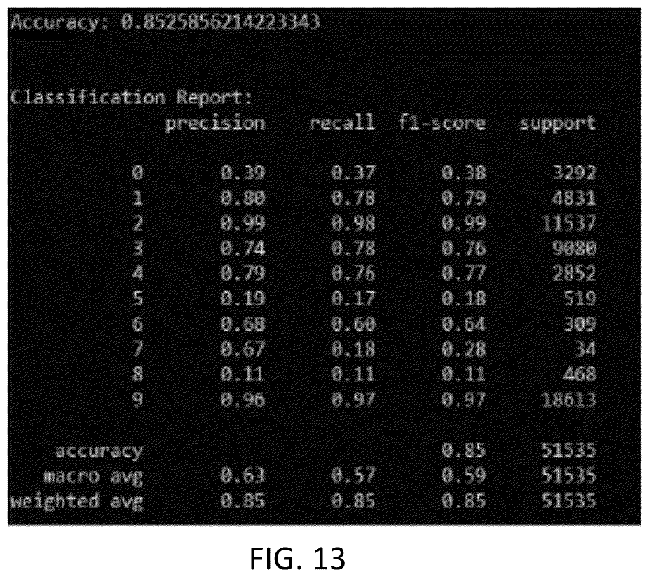

Similarly, multiclass classification accuracy for DNN is 81%. Classification reports detailing precision, recall, and F1-scores for DT and RF multiclass implementations are shown in FIGS. 12 and 13, respectively. Note that 0-9 identifiers in the FIGS. 12 and 13 represent 9 attack categories plus normal traffic (detailed mapping of identifiers to attack categories used in implementations can be referenced from Table 1100)).

Thus, Explainable Artificial Intelligence (XAI) addresses the challenge of opaque AI systems in Digital Forensics and related fields by providing easily understandable explanations for AI model predictions. The example system described herein is proposed to standardize the workflow of investigations utilizing XAI. The implementation of the framework is demonstrated in memory and network forensics investigative scenarios. In embodiments, the XAI-DF project is introduced with an initial contribution of a memory forensics database that may be utilized not only for XAI-specific DF research but generally for other DF domains as well. Some memory features including process, network, injected code, API hooks, and process privilege features are extracted from the memory database in its current form followed by classification results' explanations for interpretability.

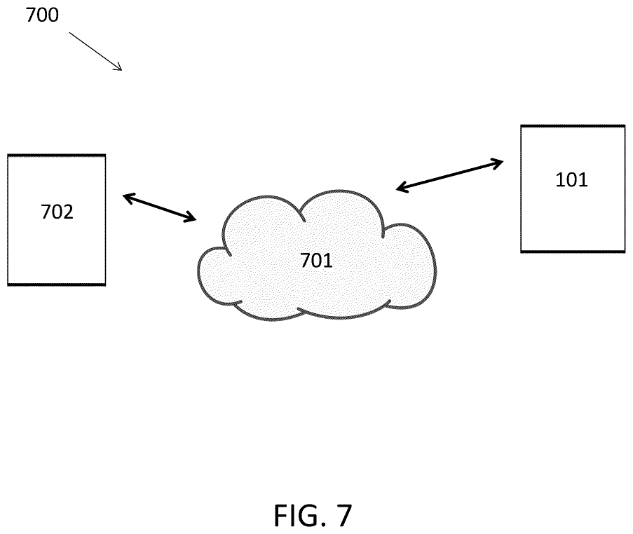

FIG. 7 is a diagram of example environment 700 in which systems, devices, and/or methods described herein may be implemented. FIG. 7 shows network 701, device 702 and XAI-DF system 101.

Network 701 may include a local area network (LAN), wide area network (WAN), a metropolitan network (MAN), a telephone network (e.g., the Public Switched Telephone Network (PSTN)), a Wireless Local Area Networking (WLAN), a WiFi, a hotspot, a Light fidelity (LiFi), a Worldwide Interoperability for Microware Access (WiMax), an ad hoc network, an intranet, the Internet, a satellite network, a GPS network, a fiber optic-based network, and/or combination of these or other types of networks. Additionally, or alternatively, network 701 may include a cellular network, a public land mobile network (PLMN), a second generation (2G) network, a third generation (3G) network, a fourth generation (4G) network, a fifth generation (5G) network, and/or another network.

In embodiments, network 701 may allow for devices to electronically communicate (e.g., using emails, electronic signals, URL links, web links, electronic bits, fiber optic signals, wireless signals, wired signals, etc.) with each other so as to send and receive various types of electronic communications.

Device 702 may include any computation or communications device that is capable of communicating with a network (e.g., network 701). For example, user device 702 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a desktop computer, a laptop computer, a tablet computer, a camera, a personal gaming system, a television, a set top box, a digital video recorder (DVR), a digital audio recorder (DUR), a digital watch, a digital glass, or another type of computation or communications device.

User device 702 may receive and/or display content. The content may include objects, data, images, audio, video, text, files, and/or links to files accessible via one or more networks. Content may include a media stream, which may refer to a stream of content that includes video content (e.g., a video stream), audio content (e.g., an audio stream), and/or textual content (e.g., a textual stream). In embodiments, an electronic application may use an electronic graphical user interface to display content and/or information via user device 702. User device 702 may have a touch screen and/or a keyboard that allows a user to electronically interact with an electronic application. In embodiments, a user may swipe, press, or touch user device 702 in such a manner that one or more electronic actions will be initiated by user device 702 via an electronic application. User device 702 may receive electronic information from XAI-DF system 101 and generate and display graphs such as those described in the figures above.

User device 702 may include a variety of applications, such as, for example, an e-mail application, a telephone application, a camera application, a video application, a multi-media application, a music player application, a visual voice mail application, a contacts application, a data organizer application, a calendar application, an instant messaging application, a texting application, a web browsing application, a blogging application, and/or other types of applications (e.g., a word processing application, a spreadsheet application, etc.). XAI-DF system 101 may include any computation or communications device that is capable of communicating with a network (e.g., network 701). In embodiments, XAI-DF system 101 may be similar to the XAI-DF system described in FIGS. 1 to 6 and 9 to 13.

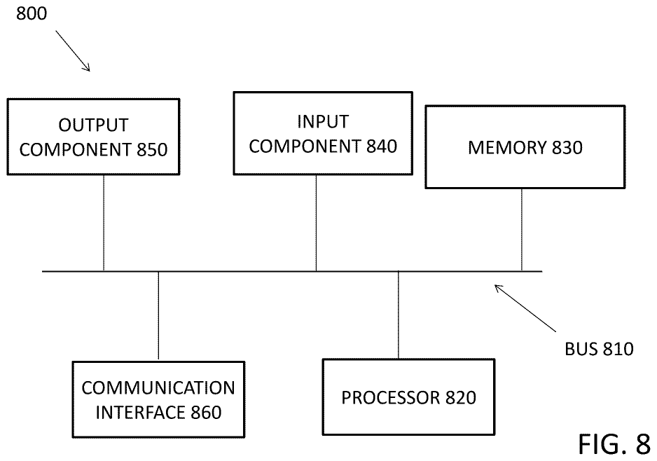

FIG. 8 is a diagram of example components of a device 800. Device 800 may correspond to user device 702, or XAI-DF system 101. Alternatively, or additionally, user device 702 and XAI-DF system 101 may include one or more devices 800 and/or one or more components of device 800.

As shown in FIG. 8, device 800 may include a bus 810, a processor 820, a memory 830, an input component 840, an output component 850, and a communications interface 860. In other implementations, device 800 may contain fewer components, additional components, different components, or differently arranged components than depicted in FIG. 8. Additionally, or alternatively, one or more components of device 800 may perform one or more tasks described as being performed by one or more other components of device 800.

Bus 810 may include a path that permits communications among the components of device 800. Processor 820 may include one or more processors, microprocessors, or processing logic (e.g., a field programmable gate array (FPGA) or an application specific integrated circuit (ASIC)) that interprets and executes instructions. Memory 830 may include any type of dynamic storage device that stores information and instructions, for execution by processor 820, and/or any type of non-volatile storage device that stores information for use by processor 820. Input component 840 may include a mechanism that permits a user to input information to device 800, such as a keyboard, a keypad, a button, a switch, voice command, etc. Output component 850 may include a mechanism that outputs information to the user, such as a display, a speaker, one or more light emitting diodes (LEDs), etc.

Communications interface 860 may include any transceiver-like mechanism that enables device 800 to communicate with other devices and/or systems. For example, communications interface 860 may include an Ethernet interface, an optical interface, a coaxial interface, a wireless interface, or the like.

In another implementation, communications interface 860 may include, for example, a transmitter that may convert baseband signals from processor 820 to radio frequency (RF) signals and/or a receiver that may convert RF signals to baseband signals. Alternatively, communications interface 860 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 860 may connect to an antenna assembly (not shown in FIG. 8) for transmission and/or reception of the RF signals. The antenna assembly may include one or more antennas to transmit and/or receive RF signals over the air. The antenna assembly may, for example, receive RF signals from communications interface 860 and transmit the RF signals over the air, and receive RF signals over the air and provide the RF signals to communications interface 860. In one implementation, for example, communications interface 860 may communicate with network 701.

As will be described in detail below, device 800 may perform certain operations. Device 800 may perform these operations in response to processor 820 executing software instructions (e.g., computer program(s)) contained in a computer-readable medium, such as memory 830, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 830 from another computer-readable medium or from another device. The software instructions contained in memory 830 may cause processor 820 to perform processes described herein. Alternatively, hardwired circuitry may be used in place of or in combination with software instructions to implement processes described herein. Thus, implementations described herein are not limited to any specific combination of hardware circuitry and software.

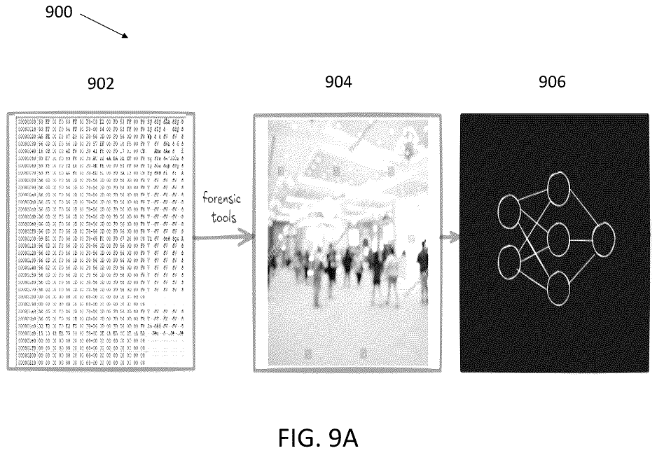

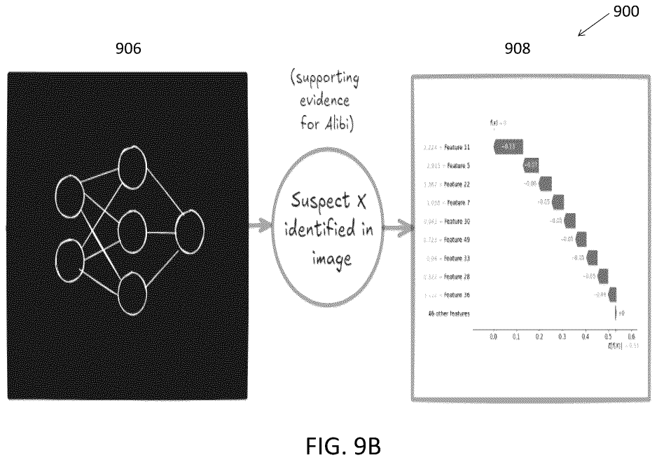

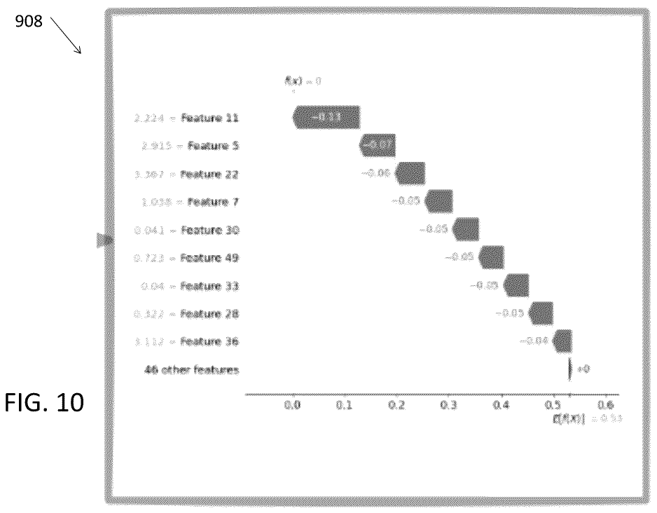

FIGS. 9A and 9B describe example process 900. In embodiments, process 900 describes an example process of obtaining forensic information and converting the forensic information into a report understandable to a person. As shown in FIG. 9A, at 902, hexadecimal data is sent to a XAI-DF system (e.g., such as XAI-DF system 101). In embodiments, the hexadecimal information is associated with electronic images (as shown in 904). In embodiments, the hexadecimal data is sent to the XAI-DF system (906). As shown in FIG. 9B, the XAI-DF system then uses datasets (generated from the inputted data) for training and testing. As shown in FIG. 9B, the XAI-DF system then generates outputs that include information about whether a suspect's alibi is valid or not. Also, as shown in FIG. 9B, the XAI-DF system generates an output graph (908 which is also shown in FIG. 10). In embodiments, the output graph (908) generated by the XAI-DF system provides a visual representation of key contributing features impacting the model's classification decisions. Negative values in the graph illustrate how certain features contribute to a classification result being more or less likely malicious. For example, a feature (e.g., Feature 11 with a value of 2.224) may have a quantified negative impact (e.g., −0.23) on the likelihood of being classified as malicious, showcasing the strength and direction of its influence on the decision.

In embodiments, the XAI-DF system's process of determining the validity of a person's validity differs significantly from facial or biometric recognition. Unlike structured data used in biometrics, in this instance the memory images are unstructured and significantly more (containing elements such as import/export tables and printable strings). As identifying relevant features in such complex data is challenging, the XAI-DF system reduces the amount of computing resources and time to conduct the process of identification. In embodiments, the XAI-DF system automates the extraction of key suspicious indicators from memory images, whereas previous models only focus on detection. Previously, forensic experts needed to manually inspect the data for signs of malicious behavior, a process that is both time-consuming and prone to human error. By streamlining and automating this step, the framework allows presenting evidence directly to decision-makers, such as judges, highlighting critical indicators of suspicious activity that can aid in their deliberations

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing and/or electronic networking environment and may require one or more computing devices, as described in FIG. 7, to complete such actions.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A system, comprising:
an explainable artificial intelligence system; and
a digital forensics system.

2. The system of claim 1, wherein the input to the system includes:
memory dumps,
network logs/packets,
hard drive/disk space (logical/physical) images
email data,
images,
audios,
videos,
cloud/server data,
mobile and IoT devices' (logical/physical) images, and
removable storage.

3. The system of claim 2, wherein the system is configured to detect malicious attacks.

4. The system of claim 3, wherein the system selects a particular model, wherein the particular model is selected from decision trees, random forests, neural networks, naive bayes, support vector machines, gradient boosting machines, and others to convert the memory dumps, the network logs, and the email data into the graphical information.

5. The system of claim 4, wherein model selection is based on input type into the system.

6. The system of claim 5, wherein the input to the system includes preprocessing the input to the system.

7. The system of claim 6, wherein the preprocessing the input to the system includes a training set, a testing set, and a validation set.
